(19) United States
(12) Patent Application Publication
(10) Pub. No.: US 2024/0335905 A1
(43) Pub. Date: Oct. 10, 2024

(54) Laser Welding Method

(71) Applicant: Kawasaki Jukogyo Kabushiki Kaisha, Kobe-shi (JP)

(72) Inventors: Osami OOGUSHI, Kobe-shi (JP); Mutsuhiro NAKAZAWA, Kobe-shi (JP)

(21) Appl. No.: 18/575,058

(22) PCT Filed: Jul. 4, 2022
(86) PCT No.: PCT/JP22/26557

§ 371 Date: Dec. 28, 2023

(30) Foreign Application Priority Data
Jul. 7, 2021 (JP) 2021-112486

(51) Int. Cl. B23K 26/08; B23K 26/064; B23K 26/26; B23K 101/38

(52) U.S. Cl. CPC B23K 26/08; B23K 26/064; B23K 26/26; B23K 2101/38

(57) ABSTRACT

A laser welding method includes a preparation process and a welding process. In the preparation process, sides of longitudinal ends of conductors (91) of two rectangular wires (90) are aligned with each other. In the welding process, the two rectangular wires (90) are welded together by a laser irradiation to an area including a boundary between end faces of the conductors (91) of the two rectangular wires (90). Once the laser has passed through a transmission optical system, the end face of the rectangular wire (90) is irradiated with the laser. The transmission optical system is rotatable, and an irradiation position of the laser to the end face changes in a first direction according to a rotation phase of the transmission optical system. In the welding process, the area including the boundary between the end faces of the conductors (91) of the rectangular wires (90) is irradiated with the pulsed laser in such a way that the first direction is parallel to a long side of the end face of the rectangular wire (90), so that the rectangular wires are welded with each other.

### TECHNICAL FIELD

This invention relates primarily to a method for welding rectangular wire using a laser.

### BACKGROUND ART

In recent years, rectangular wires have been used, for example, in motors and other electrical equipment. A rectangular wire is an electric wire in which an insulation coating is formed around a conductor with a rectangular cross section. Compared to wires with a circular cross section, rectangular wires have a higher occupancy ratio, allowing for miniaturization or higher power output of a device. When using rectangular wires as segment coils, it is necessary to weld the ends of the rectangular wires together. PTL 1 discloses a method for welding flat wires with each other.

In PTL 1, after initially end sides of the conductors of two rectangular wires are aligned together, a laser is irradiated to an end surface of a first rectangular wire. The laser is scanned in a loop to form a molten pool. A loop diameter of the laser trajectory is then increased to allow the molten pool to reach butt surfaces of the first rectangular wire and a second rectangular wire.

### PRIOR-ART DOCUMENTS

### Patent Documents

PTL 1: Japanese Patent No. 6593280

### SUMMARY OF THE INVENTION

### Problems to be Solved by the Invention

However, in the welding method of PTL 1, the molten pool formed on the first rectangular wire is larger than the molten pool formed on the second rectangular wire. In other words, the two rectangular wires are not heated evenly.

The present invention was made in view of the above circumstances, and its main purpose is to provide a method of welding two rectangular wires, using a laser to heat the two rectangular wires evenly.

### Means for Solving the Problems

The problem to be solved by the present invention is as described above, and the means for solving this problem and effects are described below.

According to an aspect of the present invention, a following laser welding method is provided. That is, the laser welding method includes a preparation process and a welding process. In the preparation process, sides of longitudinal ends of conductors of two rectangular wires are aligned with each other. In the welding process, the rectangular wires are welded together by irradiation of a pulsed laser to an area including a boundary between end faces of the conductors of the two rectangular wires with a pulsed laser. Once the pulsed laser has passed through a transmission optical system, the end face of the rectangular wire is irradiated with the pulsed laser. The transmission optical system is rotatable, and an irradiation position of the pulse laser to the end face changes in a first direction according to a rotation phase of the transmission optical system. In the welding process, the area including the boundary between the end faces of the rectangular wires is irradiated with the pulsed laser in such a way that the first direction is parallel to a long side of the end face of the rectangular wire, so that the rectangular wires are welded with each other.

This allows the two rectangular wires to be heated evenly by the laser because the pulsed laser is scanned in a direction parallel to the long side of the end face of the rectangular wire to perform the welding.

### Effects of the Invention

The invention provides a method of welding two rectangular wires, using a laser to heat the two rectangular wires evenly.

### BRIEF DESCRIPTION OF THE DRAWINGS

FIG. 1 is a perspective diagram of a laser processing device in a first embodiment.

FIG. 2 is a plan view of an optical scanning device.

FIG. 3 is a side view of the optical scanning device.

FIG. 4 is a diagram showing that a path of a laser is changed by transmission through a light-transmitting member.

FIG. 5 is a plan view of the optical scanning device scanning the laser in a first direction.

FIG. 6 is a side view of the optical scanning device scanning the laser in a second direction.

FIG. 7 is a schematic illustration of a laser trace on rectangular wires.

FIG. 8 shows the difference in the extent of the molten portions of the rectangular wires in the conventional art and in the present embodiment.

FIG. 9 is a plan view of the optical scanning device in a second embodiment scanning the laser in the first direction.

FIG. 10 is a side view showing the optical scanning device in the second embodiment scanning the laser in the second direction.

FIG. 11 is a plan view showing welding of the rectangular wires while a processing head is moved in a direction parallel to a long-side direction of the rectangular wire.

FIG. 12 is a plan view showing welding of the rectangular wire while the processing head is moved in a direction parallel to a short-side direction of the rectangular wire.

### EMBODIMENT FOR CARRYING OUT THE INVENTION

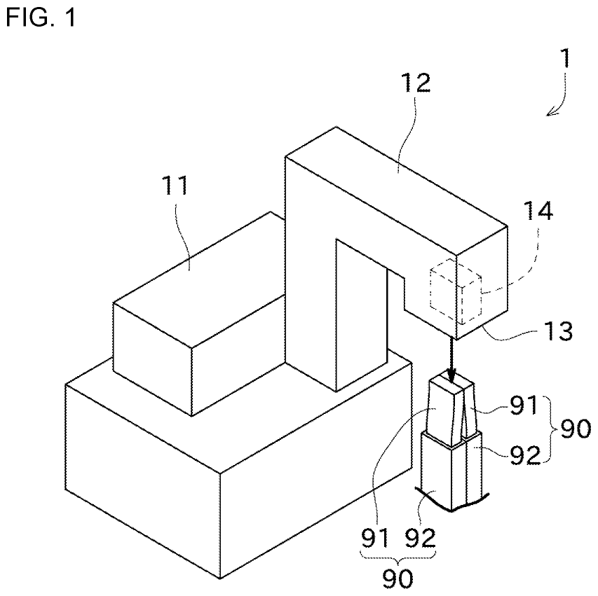

Next, embodiments of the present invention will be described with reference to the drawings First, a configuration of a laser processing device 1 is described with reference to FIG. 1. FIG. 1 is a perspective diagram of the laser processing device 1. The laser processing device 1 is used to weld a rectangular wire 90.

The rectangular wire 90 is an electric wire with an insulation coating 92 around a conductor 91 that is rectangular in cross section. When the rectangular wire 90 is used for segment coils for motors and the like, ends of the rectangular wires 90 must be welded with each other. Specifically, as shown in FIG. 1, the insulation coatings 92 of the ends of the two rectangular wires 90 are peeled off, and sides of ends of the conductors 91 of the two rectangular wires 90 are aligned with each other. In this state, the conductors 91 of the two rectangular wires 90 are welded together by laser irradiation to end faces of the conductors 91 of the two rectangular wires 90 (in particular, an area including a boundary between the two conductors 91).

As shown in FIG. 1, the laser processing device 1 includes a laser generator 11, a support member 12, and a processing head 13.

The laser generator 11 generates pulsed lasers with short time intervals due to pulse oscillation. Although the time interval of the pulsed laser is not particularly limited, the laser generator 11 generates pulsed lasers with short time intervals, for example, on the nanosecond order, picosecond order, or femtosecond order. In the following description, the “pulsed laser” generated by the laser generator 11 is simply referred to as a “laser”.

The support member 12 supports the processing head 13. A plurality of optical components (such as mirrors or prisms) are arranged inside the support member 12 to guide the laser generated by the laser generator 11 to the processing head 13. Instead of the configuration using the plurality of optical components, an optical fiber may be used to guide the laser from the laser generator 11 to the processing head 13.

The processing head 13 irradiates the rectangular wire 90 with the laser generated by the laser generator 11 and transmitted through the support member 12. The processing head 13 includes an optical scanning device 14. The processing head 13 in the present embodiment is fixed and performs welding without moving with respect to the rectangular wire 90. Instead of this configuration, the processing head 13 may be configured to perform welding while moving with respect to the rectangular line 90 (see below for details). Alternatively, the processing head 13 may perform welding by moving the rectangular wire 90 while being fixed.

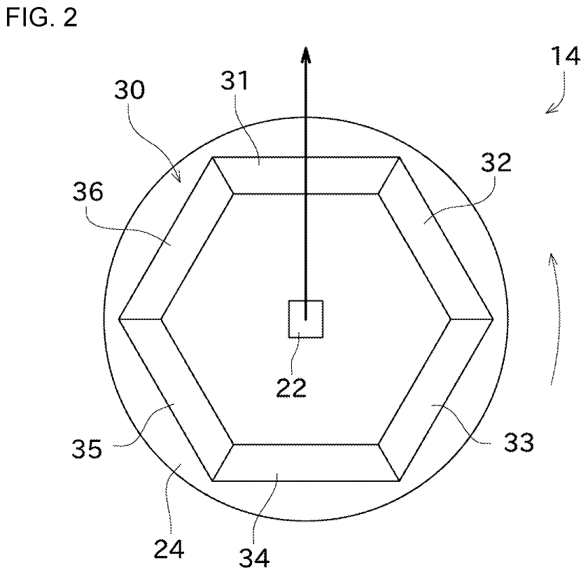

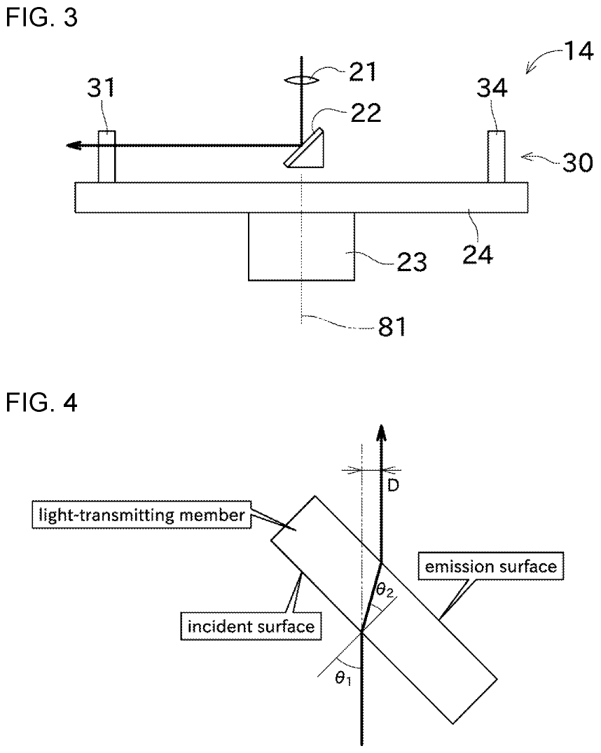

As shown in FIG. 2 and FIG. 3, the optical scanning device 14 includes a condensing member 21, a reflection member 22, an electric motor 23, a rotary table 24, and a transmission optical system 30.

The condensing member 21 is a condensing lens that condenses the laser. The condensing member 21 is not limited to a condensing lens, but may be a parabolic mirror, for example. The reflection member 22 is a mirror or a prism that reflects the laser. The reflection member 22 changes an advancing direction of the laser by reflecting the laser condensed by the condensing member 21. The laser reflected by the reflection member 22 is directed toward the transmission optical system 30.

The electric motor 23 generates rotational driving force. The rotational driving force generated by the electric motor 23 is transmitted to the rotary table 24. As a result, the rotary table 24 rotates around a rotation axis 81. The condensing member 21 and the reflection member 22 can rotate relative to the rotary table 24, and the condensing member 21 and the reflection member 22 do not rotate when the rotary table 24 rotates.

The rotary table 24 includes the transmission optical system 30. As the rotary table 24 rotates, the transmission optical system 30 also rotates integrally with the rotary table 24. The transmission optical system 30 includes a plurality of light-transmitting members that transmit the laser. Specifically, the transmission optical system 30 includes a first light-transmitting member 31, a second light-transmitting member 32, a third light-transmitting member 33, a fourth light-transmitting member 34, a fifth light-transmitting member 35, and a sixth light-transmitting member 36. The first light-transmitting member 31—the sixth light-transmitting member 36 in the present embodiment are plate-shaped members of constant thickness and are arranged side by side to form a polygon (regular hexagon in the present embodiment).

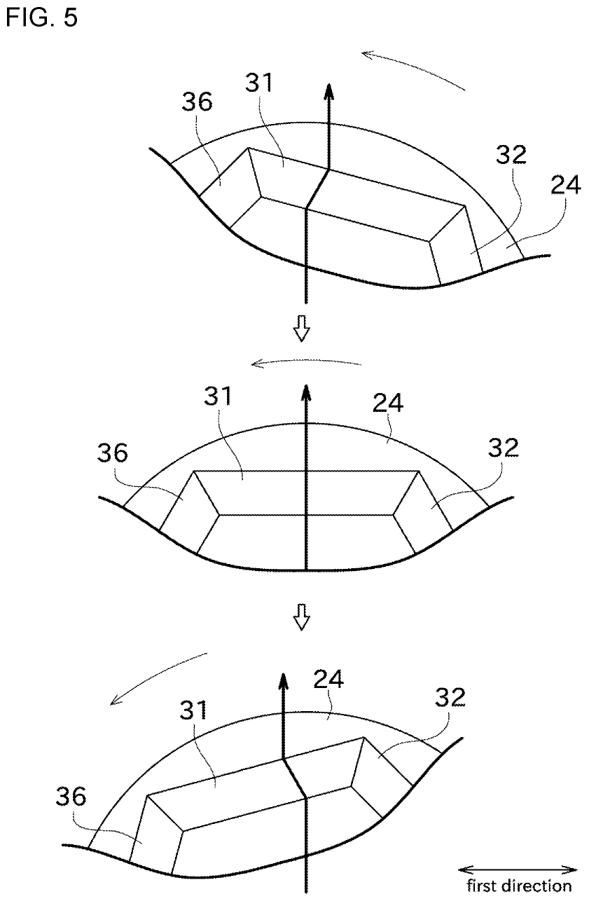

As the laser passes through the light-transmitting member, a path of the laser is changed (offset). The laser processing device 1 utilizes this principle to scan the laser. The principle of the laser path change is explained below with reference to FIG. 4. The light-transmitting member has an incident surface where the laser enters and an emission surface where the laser emits. The incident surface and the emission surface of the light-transmitting member are parallel. When the incident surface and the emission surface of the light-transmitting member are orthogonal with respect to the laser, the path of the laser does not change. When the incident surface and the emission surface of the light-transmitting member are not orthogonal with respect to the laser, the path of the laser changes.

When the laser enters the light-transmitting member, the laser is refracted. Specifically, a refraction angle θ2 is different from an incident angle θ1. The relation between the incident angle θ1 and the refraction angle θ2 depends on the ratio of the refractive index in atmosphere and the refractive index of the light-transmitting member. The laser is also refracted when the laser is emitted outward from the light-transmitting member. Since the incident surface and the emission surface of the light-transmitting member are parallel, a direction of the laser entering the light-transmitting member and a direction of the laser emitted from the light-transmitting member are parallel. However, a position of the laser entering the light-transmitting member and a position of the laser emitted from the light-transmitting member differ by a distance D.

The distance D depends on an angle of the light-transmitting member with respect to the laser, thickness of the light-transmitting member, and the ratio of the refractive index in atmosphere and the refractive index of the light-transmitting member. Since the thickness of the light-transmitting member and the ratio of the refractive index are constant in the present embodiment, the distance D varies according to the angle of the light-transmitting member with respect to the laser.

The first light-transmitting member 31—the sixth light-transmitting member 36 in the present embodiment are fixed to the rotary table 24. Therefore, rotating the rotary table 24 allows the first light-transmitting member 31—the sixth light-transmitting members 36 to be rotated. For example, when the laser passes through the first light-transmitting member 31, the angle of the first light-transmitting member 31 with respect to the laser changes according to a rotation phase of the first light-transmitting member 31 (transmission optical system 30), as shown in FIG. 5. As a result, the distance D described above varies according to the rotation phase of the first light-transmitting member 31 (transmission optical system 30) due to the principle described above. In other words, rotating the transmission optical system 30 while irradiating with the laser causes the laser to be scanned. A direction of the laser at this time is hereinafter referred to as a “first direction”.

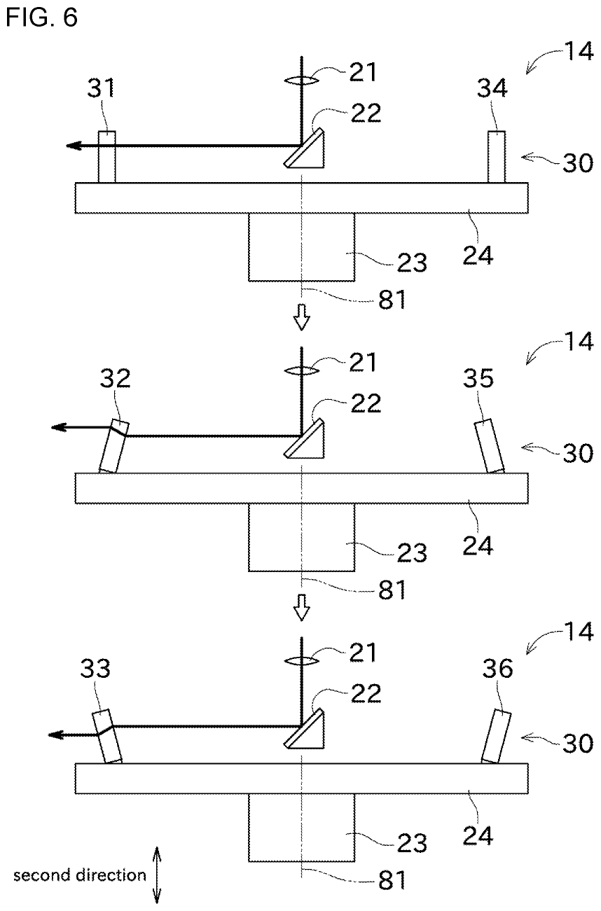

The optical scanning device 14 of the present embodiment also scans the laser in a direction orthogonal to the first direction (a second direction) utilizing the same principle. As shown in FIG. 6, the first light-transmitting member 31 and the fourth light-transmitting member 34 are upright with respect to the rotary table 24, while the second light-transmitting member 32 and the fifth light-transmitting member 35 are inclined inward (toward the rotation axis 81) and the third light-transmitting member 33 and the sixth light-transmitting member 36 are inclined outward. In other words, the angle of the light-transmitting members with respect to the laser changes as the light-transmitting member through which the laser is transmitted is switched. As a result, the distance D in the second direction varies as the light-transmitting member through which the laser is transmitted is switched. As described above, the optical scanning device 14 also scans the laser in the second direction.

In summary, while the laser passes through one light-transmitting member, an irradiation position of the laser changes in the first direction (scanning in the first direction). Then, as the rotation of the rotary table 24 progresses and the laser passes through the next light-transmitting member, the irradiation position of the laser changes in the second direction (the laser is scanned in the second direction).

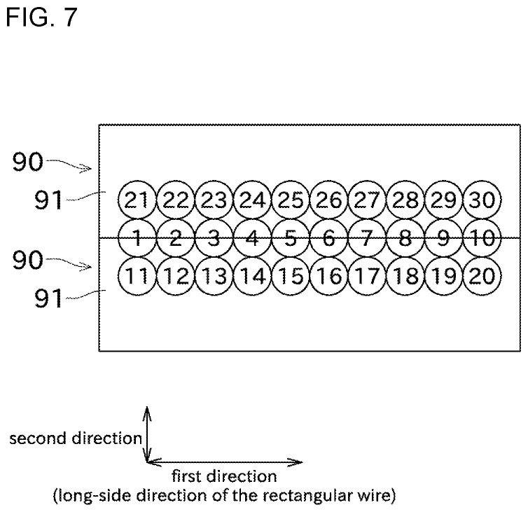

FIG. 7 schematically shows the order in which the conductors 91 of the rectangular wires 90 is irradiated with the laser. In FIG. 7, the laser traces are adjacent to each other so that the order of the laser irradiation can be easily seen, but in reality the laser traces overlap each other. In FIG. 7, the number of the laser irradiation in the first direction is 10 times, but in reality, it is highly likely that the number of the laser irradiation is more than 10 times. In FIG. 7, the laser is emitted for three rows in the second direction, but in reality, the laser is likely to be emitted for four or more rows.

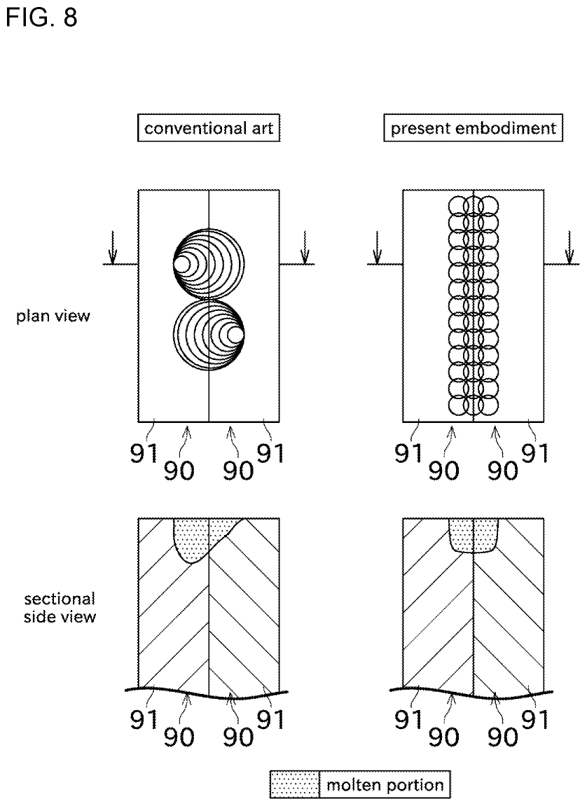

Next, referring to FIG. 7 and FIG. 8, a comparison of the welding method of the conventional art and the present embodiment is described. As shown in FIG. 7, the first direction is parallel to the long side of the cross section (rectangular shape) of the conductor 91 of the rectangular wire 90. In other words, the first direction is parallel to the line drawn by the boundary of the conductors 91 of the two rectangular wires 90 (boundary line). The area including the boundary of the end faces of the conductors 91 of the two rectangular wires 90 is irradiated with the laser and the laser is scanned in the first direction. Thus the conductors 91 of the two rectangular wires 90 are welded with each other. Since the beam diameter of the laser in the present embodiment is small, the laser is scanned in the second direction in addition to the first direction.

In the conventional method, a preparation process is initially performed to align the sides of the longitudinal ends of the conductors 91 of the two rectangular wires 90 with each other. Next, as shown in FIG. 8, the end face of the conductor 91 of one of the rectangular wires 90 is irradiated with the laser, and the laser is scanned in a loop to form a molten pool. The diameter of the laser trajectory is then increased to allow the molten pool to reach the area containing the boundary of the conductors 91 of the two rectangular wires 90.

In the conventional method, the conductor 91 of one of the rectangular wires 90 is heated intensively. Therefore, the conductors 91 of the two rectangular wires 90 are not heated evenly. Specifically, as shown in the lower figure in FIG. 8, the molten portion of the conductor 91 of the rectangular wire 90 irradiated earlier with the laser is smaller than the molten portion of the conductor 91 of the other rectangular wire 90.

In contrast, in the method of the present embodiment, as well as the conventional art, a preparation process is initially performed to align the sides of the longitudinal ends of the conductors 91 of the two rectangular wires 90 with each other. Next, a welding process is performed to weld the rectangular wires 90 together by irradiating the area including the boundary between the end faces of the conductors 91 of the two rectangular wires 90 with the laser. In the welding process, the laser is scanned along the long side of the conductor 91, as shown in FIG. 7 and FIG. 8. As a result, the conductors 91 of the two rectangular wires 90 can be melted evenly, as shown in the lower figure of FIG. 8.

In the conventional art, the program for laser irradiation tends to be complex because it is necessary to adjust the irradiation position of the laser so that the diameter increases as the loop is repeatedly drawn. In contrast, in the method of the present embodiment, if the shape, direction, or other factors of the transmission optical system 30 are determined so that a range suitable for welding the two rectangular wires 90 is irradiated with the laser, only simple placement of the rectangular wires 90 at an appropriate position with respect to the processing head 13 allows the two rectangular wires 90 to be precisely welded.

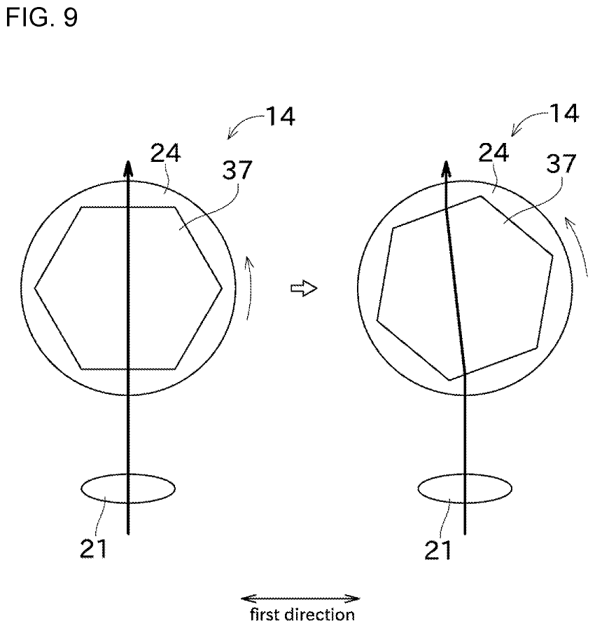

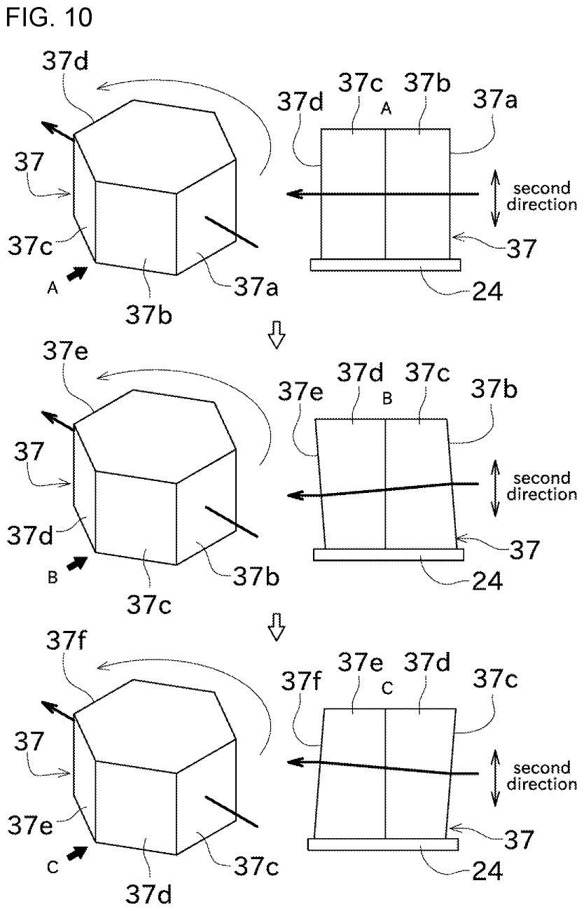

Next, with reference to FIG. 9 and FIG. 10, the optical scanning device 14 of a second embodiment is described.

The optical scanning device 14 of the second embodiment includes the condensing member 21, the rotary table 24, and the light-transmitting member 37. As shown in FIG. 9, the light-transmitting member 37 is a hexagonal shape. The light-transmitting member 37 is fixed to the rotary table 24. In detail, the light-transmitting member 37 is fixed to the rotary table 24 so that the center of the light-transmitting member 37 and the center of the rotary table 24 (i.e., the rotation axis 81) are aligned. Rotating the rotary table 24 allows the light-transmitting member 37 to rotate. On the other hand, the condensing member 21 does not rotate when the rotary table 24 rotates.

As shown in FIG. 9, in the light-transmitting member 37, the incident surface where the laser (thick line in the figure) enters and the emission surface where the laser is emitted from the light-transmitting member 37 are parallel. The incident angle of the laser changes according to the rotation phase of the light-transmitting member 37. Therefore, due to the principle described using FIG. 4, the path of the laser changes according to the rotation phase of the light-transmitting member 37. Thus, in the second embodiment, the laser is also scanned in the first direction.

The optical scanning device 14 of the second embodiment can further scan the laser in the second direction. The configuration of scanning the laser in the second direction is described below with reference to FIG. 10. FIG. 10 shows three pairs of perspective views and side views showing how the laser passes through the light-transmitting member 37.

As shown in FIG. 10, the light-transmitting member 37 includes a first side 37a, a second side 37b, a third side 37c, a fourth side 37d, a fifth side 37e, and a sixth side 37f. The first side 37a and the fourth side 37d are positioned facing each other, the second side 37b and the fifth side 37e are positioned facing each other, and the third side 37c and the sixth side 37f are positioned facing each other.

The perspective view and the side view at the top of FIG. 10 show the laser entering the first side 37a and emitted from the fourth side 37d. As shown in the side view, the first side 37a and the fourth side 37d are upright with respect to the rotary table 24. Therefore, when the laser enters the first side 37a and is emitted from the fourth side 37d, the position of the laser in the second direction does not change. Similarly, if the laser enters the fourth side 37d and is emitted from the first side 37a, the position of the laser in the second direction does not change.

The perspective view and the side view at the center in FIG. 10 show the laser entering the second side 37b and emitted from the fifth side 37e. As shown in the side view, the second side 37b and the fifth side 37e are inclined downstream of the laser with respect to the perpendicular line of the rotary table 24. In other words, the second side 37b and the fifth side 37e are not orthogonal to the laser. Therefore, when the laser enters the second side 37b and is emitted from the fifth side 37e, the position of the laser in the second direction changes (more specifically, the position changes toward closer to the rotary table 24). Similarly, if the laser enters the fifth side 37e and is emitted from the second side 37b, the position of the laser in the second direction changes.

The perspective view and the side view at the bottom in FIG. 10 show the laser being entered into the third side 37c and emitted from the sixth side 37f. The direction of inclination of the third side 37c and the sixth side 37f is opposite to that of the second side 37b and the fifth side 37e. Thus, when the laser enters the third side 37c or the sixth side 37f, the position of the laser in the second direction changes (more specifically, the position changes toward away from the rotary table 24).

In summary, while the laser passes through one of the faces of the light-transmitting member 37, the irradiation position of the laser changes in the first direction (the laser is scanned in the first direction). Then, when the laser passes through the next face of the light-transmitting member 37, the irradiation position of the laser changes in the second direction (the laser is scanned in the second direction). Thus, in the second embodiment, the laser can be scanned in the same way as in the first embodiment.

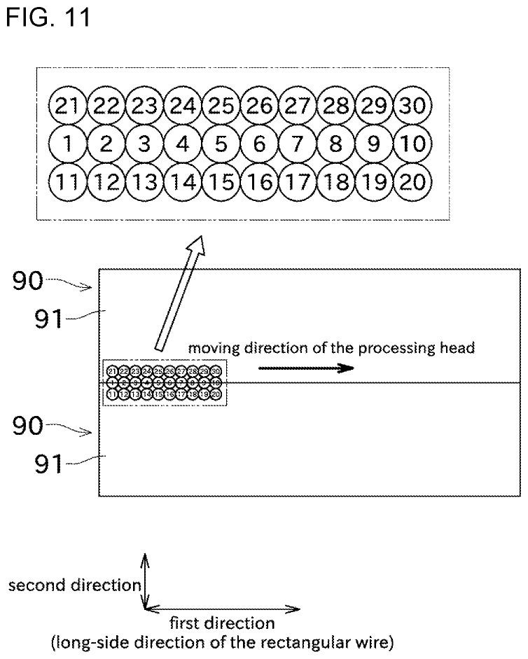

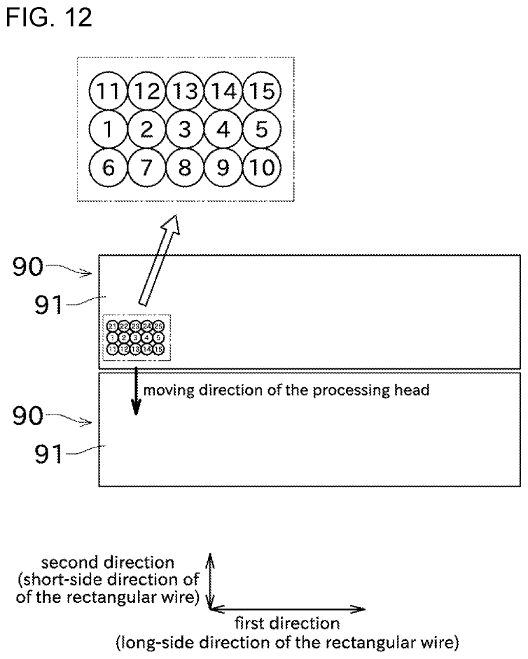

Referring to FIG. 11 and FIG. 12, a method of welding the rectangular wires 90 while the processing head 13 being moved is described.

FIG. 11 shows a situation in which welding the rectangular wire 90 is performed while the processing head 13 is moved in a direction parallel to the long side of the rectangular wire 90. In this case, the length of the laser scanned in the first direction by the optical scanning device 14 can be reduced compared to the length of the long side of the rectangular wire 90.

FIG. 12 shows a situation in which welding the rectangular wire 90 is performed while the processing head 13 is moved in a direction parallel to the short side of the rectangular wire 90. After the laser processing device 1 moves the processing head 13 in the direction parallel to the short side of the rectangular line 90, the processing head 13 is moved in the first direction with respect to the rectangular wire 90. Thereafter, the laser processing device 1 welds the rectangular wire 90 while moving the processing head 13 again in the direction parallel to the short side of the rectangular wire 90. By performing the method shown in FIG. 12, the rectangular wires 90 can be properly welded together even if there is a gap between the boundaries of the rectangular wires 90 to be welded.

As explained above, the laser welding method includes the preparation process and the welding process. In the preparation process, the sides of the longitudinal ends of the conductors 91 of the two rectangular wires 90 are aligned with each other. In the welding process, the rectangular wires 90 are welded together by irradiation of the laser to the area including the boundary between the end faces of the conductors 91 of the two rectangular wires 90. Once the laser has passed through the transmission optical system 30, the end face of the rectangular wire 90 is irradiated with the laser. The transmission optical system 30 is rotatable, and the irradiation position of the laser to the end face changes in the first direction according to the rotation phase of the transmission optical system 30. In the welding process, the area including the boundary between the end faces of the conductors 91 of the rectangular wires 90 is irradiated with the pulsed laser in such a way that the first direction is parallel to the long side of the rectangular wire 90, so that the rectangular wires 90 are welded with each other.

This allows the two rectangular wires 90 to be heated evenly by the laser because the laser is scanned in the direction parallel to the long side of the end face of the rectangular wire 90 to perform the welding.

In the present embodiment, the irradiation position of the laser to the end face of the conductor 91 of the rectangular wire 90 also changes in the second direction, which is orthogonal to the first direction on the end face, according to the rotation phase of the transmission optical system 30.

This allows not only the boundary of the conductors 91 of the two rectangular wires 90 but also the surrounding area to be irradiated with the laser. Thus, rectangular wires 90 can be welded to each other more appropriately.

In the present embodiment, the laser is emitted from the processing head 13 toward the conductor 91 of the rectangular wire 90. In the welding process, welding the rectangular wires 90 with each other is completed with relative positions of the processing head 13 and the rectangular wires 90 being fixed.

This allows the welding process to be completed in a shorter time because there is no need to move the processing head 13 or the rectangular wire 90.

In the present embodiment, the laser is emitted from the processing head 13 toward the conductor 91 of the rectangular wire 90. In the welding process, the rectangular wires are welded with each other by the pulsed laser irradiation while the processing head 13 is moved relative to the rectangular wires 90 in the direction parallel to the long side of the rectangular wire 90 or in the direction parallel to the short side of the rectangular wire 90.

This allows welding of the rectangular wires together even when the scanning range of the laser is smaller compared to the rectangular wire.

While the above is a description of a suitable embodiment of the present invention, the configuration described above can be modified as follows, for example.

The structure of scanning the laser in the first direction is an example, and an optical scanning device other than the structure described above may be used.

In the above embodiment, the optical scanning device 14 scans the laser in the first and second directions. Alternatively, the optical scanning device 14 may be configured to scan the laser in the first direction only.

1-4. (canceled)

5. A laser welding method, comprising:
(a) aligning sides of longitudinal ends of conductors of two rectangular wires with each other;
(b) welding the rectangular wires together by irradiating an area including a boundary between end faces of the conductors of the two rectangular wires with a pulsed laser; and
(c) once the pulsed laser has passed through a transmission optical system, irradiating the end face of the rectangular wire with the pulsed laser,
wherein the transmission optical system is rotatable, and an irradiation position of the pulsed laser to the end face changes in a first direction according to a rotation phase of the transmission optical system, and
wherein, in step (b), the area including the boundary between the end faces of the rectangular wires is irradiated with the pulsed laser in such a way that the first direction is parallel to a long side of the end face of the rectangular wire, so that the rectangular wires are welded with each other.

6. The laser welding method according to claim 5, wherein the irradiation position of the pulsed laser to the end face further changes in a second direction orthogonal to the first direction on the end face according to the rotation phase of the transmission optical system.

7. The laser welding method according to claim 5, wherein the pulsed laser is emitted from a processing head to the conductor of the rectangular wire, and wherein in step (b), welding the rectangular wires with each other is completed with relative positions of the processing head and the rectangular wire fixed.

8. The laser welding method according to claim 5, wherein the pulsed laser is emitted from a processing head to the conductor of the rectangular wire, and wherein in step (b), the rectangular wires are welded with each other by the pulsed laser irradiation while the processing head is moved relative to the rectangular wire in a direction parallel to the long side of the rectangular wire or in a direction parallel to a short side of the rectangular wire.
